(19) United States
(12) Patent Application Publication
(10) Pub. No.: US 2013/0076960 A1
(43) Pub. Date: Mar. 28, 2013

(54) IMAGING DEVICE AND IMAGING METHOD

(71) Applicants: Daniel Bublitz, Rausdorf (DE); Marco Wilzbach, Stuttgart (DE); Christian Albrecht, Aalen (DE); Christoph Nieten, Jena (DE); Enrico Geissler, Jena (DE)

(72) Inventors: Daniel Bublitz, Rausdorf (DE); Marco Wilzbach, Stuttgart (DE); Christian Albrecht, Aalen (DE); Christoph Nieten, Jena (DE); Enrico Geissler, Jena (DE)

(21) Appl. No.: 13/624,915

(22) Filed: Sep. 22, 2012

(30) Foreign Application Priority Data
Sep. 23, 2011 (DE) 102011083353.6

(51) Int. Cl. H04N 5/222

(52) U.S. Cl. 348/333.01; 348/E05.022

(57) ABSTRACT

An imaging includes an image acquisition module which has an image sensor and a first lens system, having a focal plane, for imaging an object onto the image sensor, a display module which displays the image captured by means of the image acquisition module such that a user can perceive it with one eye, and a control unit. A measuring module is provided to the control unit for measuring the accommodation state (B₁(t)) of the eye of the user. The control unit adjusts the position of the focal plane of the first lens system on the basis of the measured accommodation state (B₁(t)) and, at the same time, adjusts displaying of the image by means of the display module on the basis of the measured accommodation state (B₁(t)) such that the user can perceive the displayed image in sharp definition with his eye having the measured accommodation state (B₁(t)).

### PRIORITY

The present application claims priority to German Application No. 102011083353.6, filed Sep. 23, 2011, which is hereby incorporated by reference in its entirety.

### FIELD

The present invention relates to an imaging device with an image acquisition module which has an image sensor and a first lens system, having a focal plane, for imaging an object onto the image sensor, a display module which displays the image captured by means of the image acquisition module such that a user can perceive it with one eye, and a control unit, as well as an imaging method in which an object is imaged onto the image sensor with an image acquisition module which comprises an image sensor and a first lens system having a focal plane, and the image captured by means of the image acquisition module is displayed with a display module such that a user can perceive it with one eye. Such an imaging device can be e.g. a digital microscope in which the image is presented digitally via the display module.

### BACKGROUND

With conventional optical microscopes, the user is accustomed to focussing through accommodation of the eyes in the object to be observed over several depths of field. For an impression of the depth of the object to be observed, focusing in the sample is very important for the observer and, in addition to stereo observation for close objects, delivers the best criterion for a three-dimensional orientation inside the sample (depth perception).

This is no longer possible with an imaging device of the type named at the beginning, as the image is presented to the user via the display module, with the result that accommodation of the eyes would only result in the observer no longer being able to perceive the displayed image in sharp definition.

### SUMMARY

It is an object of certain embodiments of the invention to provide an imaging device of the type named at the beginning, as well as an imaging method of the type named at the beginning, such that a depth perception is possible for a user.

According to certain embodiments of the invention, the object is achieved with an imaging device of the type named at the beginning in that a measuring module is provided for measuring the accommodation state of the eye of the user, and the control unit adjusts the position of the focal plane of the first lens system on the basis of the measured accommodation state and, at the same time, adjusts displaying of the image by means of the display module on the basis of the measured accommodation state such that the user can perceive the displayed image in sharp definition with his eye having the measured accommodation state.

With the imaging device according to the invention, depth perception is thus made possible or reproduced for the user in that the sample plane which he selects through his accommodation state is always presented to him in sharp definition. The user is thus provided with a visual impression that is as natural as possible, such as he is accustomed to from an entirely optical system. Thus, a digital observation system or an observation system having a digital eyepiece which allows a refocusing inside the object can be realized with the imaging device according to the invention.

The imaging device can be formed as a microscope, a 3D microscope, a night vision device, or another imaging device.

If the imaging device is formed as a microscope, it can be formed in particular as a stereo microscope. Thus, it then becomes possible to represent the object three-dimensionally for the user, wherein, at the same time, a refocusing is possible for the user in this three-dimensional representation.

The display module can have an imaging system and a second lens system which projects the image generated by means of the imaging system into an image plane, wherein the control unit adjusts the position of the image plane on the basis of the measured accommodation state. The display of the image by means of the display module can thus easily be adapted to the measured accommodation state of the eye.

The image displayed by means of the display module can be subjected to image processing again before display. Thus the image that is displayed need not be precisely the image that is captured by means of the image sensor, but known image processing, such as e.g. the use of filters, can have been carried out beforehand. False colour representation or another processing is also possible.

The second lens system can project the image generated by means of the imaging system as a virtual image. A digital eyepiece is thus provided which the user can use in the same way as an optical eyepiece in a conventional microscope.

In particular, the refractive power of the second lens system can be alterable in order to adjust the position of the image plane. Furthermore, alternatively or additionally, the distance between the second lens system and the imaging system can be alterable in order to adjust the position of the image plane. In this way, the desired position of the image plane can easily be adjusted.

However, it is also possible for the display module to have only one imaging system and in this case the position of the imaging system can be altered in order to carry out the adaptation to the measured accommodation state.

The refractive power of the second lens system can be generated in a multi-lens system by changing the distance between the lenses. It is also possible to use one or more lenses with variable refractive power.

In the imaging device according to certain embodiments of the invention, the measuring module can measure the accommodation state of the eye confocally. For this, the measuring module can include e.g. a light source which emits a light beam, an optical system which guides the light beam into the eye of the user, and a detector, wherein the light beam reflected at the fundus of the eye is directed via the optical system onto the detector, which emits a detector signal which is evaluated to determine the accommodation state. In particular, two detectors can be provided which are each positioned at a different optical distance from the eye, with the result that the accommodation state can be deduced from the two detector signals. It is also possible to provide the two detectors movable such that the optical distance of both detectors from the eye is altered in the same way by a movement. In this case, e.g. if both detector signals are the same, the accommodation state can be deduced from the movement.

The measuring module can alternatively have at least one wavefront sensor in order to determine the accommodation state of the eye based on the curvature of the wavefront which is caused by the reflection of the measurement radiation at the eye.

In the imaging device according to certain embodiments of the invention, the control unit can alter the position of the focal plane of the first lens system such that this alteration is proportional to the measured alteration of the accommodation state of the eye. In this case, there is a proportional relationship. Alternatively, it is possible for the control unit to alter the position of the focal plane of the first lens system such that there is a functional relationship to the measured alteration of the accommodation state of the eye, wherein the functional relationship is not a proportional relationship. The imaging device can be developed such that the functional relationship can be adjusted in a user-specific manner.

The measuring module can use infrared radiation to measure the accommodation state of the eye. Furthermore, it is possible for the measuring module to measure the accommodation state of the eye continuously or periodically. This reduces the measurement outlay.

The image acquisition module can be formed as a camera, microscope, electron microscope, etc.

The display module can be formed such that it has a basic setting in which the imaging system is not projected into an infinite distance. In particular, the imaging system can be projected into a distance of less than 100 cm.

The measuring module can use infrared radiation (in particular with a wavelength from the range of 800-1060 nm) to measure the accommodation state. This radiation is not visible to the user, and therefore does not trouble him.

The imaging device according to certain embodiments of the invention can be formed such that it measures the accommodation state of both eyes and uses this measurement to carry out an automatic dioptre adjustment between the two eyes.

In the imaging device according to certain embodiment of the invention, the captured image is displayed to the user, also called first user in the following, by means of the display module, also called first display module in the following, such that the user can perceive it with at least one eye. The imaging device according to the invention can have a second display module which displays the captured image to a second user. In this case, the control unit can control the second display module on the basis of the measured accommodation state of the eye of the first user such that the image is presented to the second user with the same focal position as to the first user. The first user can thus be described as the main observer who specifies the displayed focal position via the accommodation state of his eye.

The object is achieved according to certain embodiments, in an imaging method of the type named at the beginning, in that the accommodation state of the eye of the user is measured and the position of the focal plane of the first lens system is adjusted on the basis of the measured accommodation state and, at the same time, displaying of the image by means of the display module is adjusted on the basis of the measured accommodation state such that the user can perceive the displayed image in sharp definition with his eye having the measured accommodation state.

In the imaging method according to certain embodiments of the invention, the display module can project the image as a virtual image.

Furthermore, the accommodation state of the eye can be measured continuously.

The position of the focal plane of the first lens system can be altered such that this alteration is proportional to the measured alteration of the accommodation state of the eye. In addition to this proportional relationship, the alteration can also be carried out such that there is a functional relationship between the alteration of the position of the focal plane of the first lens system and the measured alteration of the accommodation state of the eye which is not a proportional relationship. In particular, the relationship between the alteration of the position of the focal plane and the alteration of the measured accommodation state can be adjusted in user-specific manner.

The imaging method according to certain embodiments of the invention can be developed such that it comprises the steps which are given in connection with the imaging device according to the invention including its developments and the embodiments yet to be described below.

It is understood that the features mentioned above and those yet to be explained below can be used, not only in the stated combinations, but also in other combinations or alone, without departing from the scope of the present invention.

### BRIEF DESCRIPTION OF THE DRAWINGS

The invention is explained in further detail below by way of example using the attached drawings which also disclose features essential to the invention. There are shown in:

FIG. 1, which is a schematic view of an embodiment of the imaging device according certain embodiments of the invention.

FIG. 2, which is a design of the measuring module 5 of FIG. 1.

FIG. 3, which is a schematic representation of the imaging device according to certain embodiments of the invention to illustrate the basic principle according to the invention.

### DETAILED DESCRIPTION

In the following descriptions, the present invention will be explained with reference to example embodiments thereof. However, these example embodiments are not intended to limit the present invention to any specific example, environment, embodiment, applications or particular implementations described in these example embodiments. Therefore, descriptions of these example embodiments are only for purposes of illustration rather than limitation to the invention. It should be appreciated that in the following example embodiments and the attached drawings, elements unrelated to the present invention are omitted from depiction; and dimensional relationships among individual elements in the attached drawings are illustrated only for ease of understanding, but not to limit the actual scale.

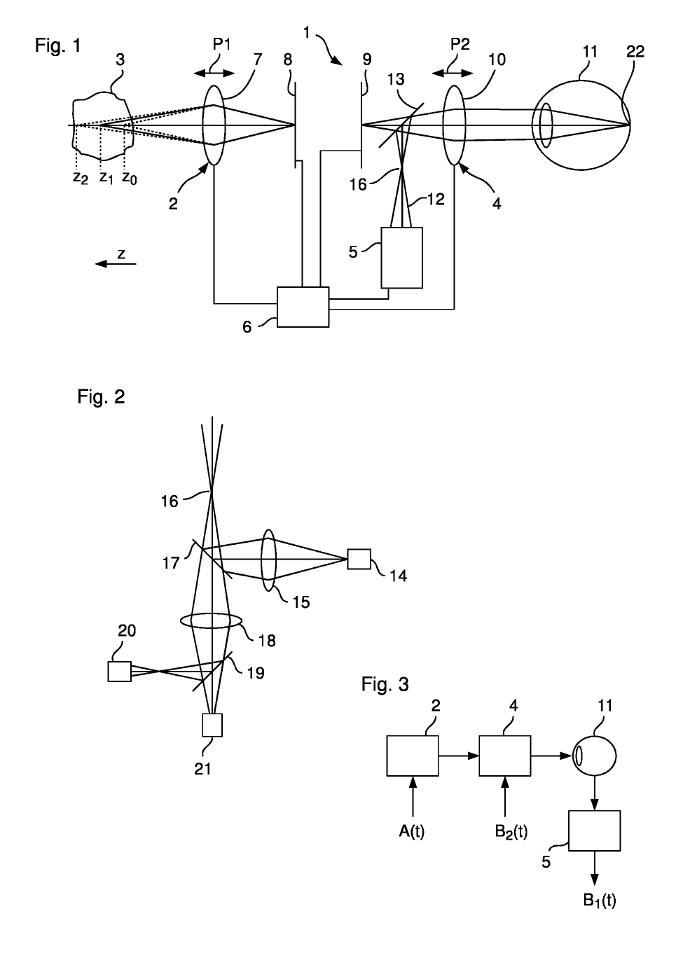

In the example embodiment shown in FIG. 1, the imaging device 1 according to the invention is formed as a digital microscope, which comprises an image acquisition module 2 for capturing magnified pictures of an object 3, a display module 4 which is formed as a digital eyepiece system, a measuring module 5, as well as a control unit 6.

The image acquisition module 2 has an imaging lens system 7 as well as an image sensor 8 which is e.g. a CCD sensor or a CMOS sensor. The imaging lens system 7 is, as represented by the double arrow P1, movable in z direction, with the result that the position of the focal plane which the imaging lens system 7 projects in sharp definition onto the image sensor 8 is movable in z direction. The position z₁, just adjusted, of the focal plane is indicated with continuous lines in FIG. 1. When moved in z direction, the position of the focal plane can be altered or adjusted e.g. between the values z₀ and z₂.

The display module 4 comprises an imaging system 9 which can represent an image in 2D and comprises for example an LCD module or an LCoS module, as well as a second lens system 10 which projects the imaging system 9 such that the image represented by means of the imaging system 9 is presented to a user as a virtual image. An eye 11 is drawn in to represent the user in FIG. 1. The second lens system 10 is movable along the z direction, as indicated by the double arrow P2, whereby the position of the virtual image is movable along the z direction.

The measuring module 5 serves to measure the accommodation state, wherein a measurement beam path 12 is coupled into the observation beam path of the display module 4, and thus into the eye 11, via a splitter 13.

A design of the measuring module 5 is shown in FIG. 2. The measuring module 5 contains a point light source 14, such as e.g. an LED, a laser source, in particular a VCSEL, an SLD, etc. The point light source 14 is projected into a plane 16, which is conjugate to the plane of the imaging system 9, by means of a first measuring module lens system 15. As the measurement beam path 12 is coupled into the observation beam path via the splitter 13, the point light source is imaged in a focussed manner onto the retina plane 22 of the eye 11.

The light scattered back from the retina of the eye 11 passes through the beam path in reverse direction and reaches a second measuring module lens system 18, which carries out a projection into a further intermediate image plane, through the second splitter 17. Between the second measuring module lens system 18 and the further intermediate image plane there is a third splitter 19 which projects the light, in roughly equal portions, onto two detectors 20, 21, wherein the detector 20 is arranged just behind the further intermediate image plane and the detector 21 just in front of the further intermediate image plane.

The intensity signal of the two detectors 20, 21 is fed to the control unit 6. The imaging device 1 according to the invention is designed such that the user perceives the virtual image presented by means of the display module 4 in sharp definition with his eye 11 if the two intensity signals of the two detectors 20 and 21 are of equal size. In this case, the position of the virtual image corresponds to the just present accommodation state of the eye 11. If the two intensity signals of the two detectors 20 and 21 differ from each other, there is a difference between the position of the virtual image and the accommodation state of the eye 11, wherein it can be ascertained from the sign of the difference whether the virtual image lies in front of the eye 11 or behind the eye 11.

In operation, a picture of the object 3 is captured with the image acquisition module 2 by means of the imaging device according to the invention and the picture is fed to the control unit 6. The control unit 6 controls the display module 4 which represents the captured image by means of the imaging system 9. At the same time, the accommodation state of the eye 11 is measured with the measuring module 5 and the position of the virtual image is adapted to the measured accommodation state of the eye 11 via the second lens system 10, with the result that the user can perceive the presented virtual image in sharp definition. If the user now alters the focussing with his eye, and thus the accommodation state of the eye 11, in order to observe another depth plane of the represented object 3, this is detected by the measuring module 5 which continuously measures the accommodation state of the eye 11. The control unit 6 then alters the position of the focal plane by moving the imaging lens system 7 (for example towards the position z₀) and the display module 4 is controlled by the control unit 6 such that the position of the represented virtual image is adapted to the altered accommodation state. Although the distance between the eye 11 and the imaging system 9 has not changed, for the user the position of the represented virtual image has moved in z direction. The impression of natural vision is thus reproduced. In the imaging device according to the invention, the user can focus with his eye 11 and thereby change the depth plane of the perceptible (imaged) object 3.

The principle on which the imaging device according to the invention is based is to be further explained with reference to the schematic functional representation according to FIG. 3.

The display module 4 is in the state B₂(t). This state describes the position of the virtual image which the display module 4 represents.

The accommodation state of the eye 11 is called B₁(t) and is measured continuously.

The position of the focal plane of the image acquisition module 2 is called z(t) and can lie between z₀ and z₂. The state is called A(t).

The measured accommodation state B₁(t) is now used to always project the imaging system 9 in sharp definition, independently of the accommodation state B₁(t), and thus adjust the state B₂(t). Furthermore, the accommodation state B₁(t) is used to adjust the state A(t) of the image acquisition module 2. There can be a linear relationship between the two states B₁(t) and A(t), wherein the proportionality factor can be 1 or else not equal to 1. Thus, e.g. a small alteration of B₁(t) can be converted to a large alteration of A(t) or vice versa. Furthermore, there need not be a linear relationship between the states B₁(t) and A(t), with the result that any adaptation to the physical accommodation curves is possible. A(t) and thus z(t) can be any function of B₁(t).

In particular, e.g. an adaptation to the age of the user can be carried out, as it is known that the accommodation capacity decreases significantly with increasing age. This can be realized easily by decoupling A(t) and B₁(t). Thus, e.g. age-dependent presbyopia can be counteracted. According to the invention, the conversion of the measured accommodation state B₁(t) into an alteration of the position of the focal plane (state A(t)) can thus be adapted to the accommodation capacity of the user and/or to the requirements of the application.

Furthermore, the variability of B₁(t) may be insufficient for an application (e.g. presbyopia). In this case, the dynamic range of B₁(t) can be adapted as desired by B₂(t) of the display module 4.

In the design of the measuring module 5 shown in FIG. 2, all types of confocal sensors can be used for the detectors 20 and 21. It is also possible to provide only a single detector for measurement. In this case, the third splitter 19 can be dispensed with and the detector (e.g. detector 21) must be moved beyond the focal point. The position of the highest signal on the detector 21 is then a measure of the sought focal position. Such a sensor is constructed in a technically more simple way than the confocal sensors according to FIG. 2.

In the design according to FIG. 2 with the two confocal detectors 20 and 21, no movement of one of the detectors 20 and 21 is necessary, whereby a faster measurement can be carried out. The confocal detectors 20 and 21 can be formed e.g. such as according to FIG. 2 of DE 10 2005 022 125 A1. The corresponding description in DE 10 2005 022 125 A1 is hereby included by reference. In these sensors, each position inside a wide capture range about the focal point can be measured with high precision and maintained. Such sensors can be used in non-movable manner and the focus error signal can be used directly for control. Another advantage of these sensors is that they also measure larger focus errors and thus make possible a very rapid refocusing without time-consuming iteration.

Wavefront sensors represent a further possibility for measuring the accommodation state of the eye 11. These use an illumination source similar to the confocal sensors and, on the illumination side, also the same beam path as in FIG. 2. However, on the detection side, the light is detected with a Shack-Hartmann sensor which, instead of the elements 18-21, has a spatially resolving sensor with lens systems (e.g. microlens array) divided in the pupil/aperture. A dot pattern then forms on the detector and the wavefront shape of the measurement light on leaving the eye can be calculated from the distance between the dots on the detector. The accommodation state or the refraction value of the eye can then be deduced from this wavefront shape.

As, for the application described here, only the curvature of the wavefront (=refraction value) of the eye 11 and not the precise shape of the wavefront is to be measured, significantly simplified Shack-Hartmann sensors with a few sub-apertures (e.g. two, four or six) are sufficient.

The imaging device according to the invention can also be described as follows. It comprises an image acquisition module 2 which has an image sensor 8 and a first lens system 7, having a focal plane, for imaging an object 3 onto the image sensor 8, a display module 4 which displays the image captured by means of the image acquisition module 2 such that a user can perceive it with his eye 11, and a measuring module 5 for measuring the accommodation state of the eye 11 of the user. Furthermore, the imaging device comprises a first control loop with the measuring module 5 and the image acquisition module 2, wherein the measuring module 5 emits a signal with which a parameter of the image acquisition module 2 or the image acquisition module 2 itself is controlled, and a second control loop which comprises the measuring module 5 and the display module 4, wherein the measuring module 5 emits a control signal with which the imaging of the image is adjusted by means of the display module 4 such that the displayed image is projected in sharp definition onto the retina of the user's eye 11 which has the measured accommodation state.

In the embodiments up to now, the lens 7 of the image acquisition module was moved in z direction in order to alter the position of the focal plane. However, it is also possible to provide variable optical elements the refractive power of which is changeable in order to alter the position of the focal plane. Free-form elements moved towards each other can also be used. This applies in the same way to the second lens system 10 of the display module 4.

The focal position or the accommodation state of the eye is preferably determined in the IR wavelength range.

In the description up to now, adaptation to one eye of the user was the starting point. Naturally, the imaging device can also be formed binocularly and the described adaptation can be carried out for each of the two eyes. Furthermore, when determining the accommodation in both eyes, an automatic dioptre adjustment between the eyes can be carried out.

The measuring module 5 can be formed such that the light coming from the point light source 14 and focussed onto the retina plane 22 of the eye 11 is polarized (e.g. linearly polarized). The detection of the back-scattered light by means of the detectors 20 and 21 is then detected linearly polarized perpendicular to the initial polarization. In this way, an almost polarization-crossed detection can be carried out, with the result that undesired scattered light which is reflected by other boundary surfaces and not by the retina is suppressed. For example, scattered light from the cornea and the second lens system 10 can be suppressed. The light reflected by the retina can be detected because the polarization of the light changes when passing through the cornea and when being scattered at the retina and thus can be partially transmitted and detected by the crossed detection polarizer. The precision of the method can thus be increased.

This can technically be carried out in that a corresponding polarizer is positioned in front of the point light source 14 and a corresponding polarizer in front of the two detectors 20 and 21. In particular, the beam splitter 17 e.g. can be designed as a polarizing beam splitter. Naturally, linear polarization need not be used. Other polarization states orthogonal to each other can also be used.

In addition, it is possible to provide an individual spatially resolving detector instead of the two detectors 20 and 21 and the beam splitter 19 in the measuring module 5, wherein the measured spot size (or the size of the circle of confusion) can be measured. Naturally, the intensity can also be measured in addition. The measurement signals are then fed to the control unit 6 in the described way.

The spatially resolving detector can be formed as a spatially resolving CMOS or CCD sensor or else as a surface-separated sensor with two or more individually releasable part-surfaces. Arrangements with extra-axial quadrant diodes or PSDs or else diode arrays are also possible.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An imaging device, comprising:
an image acquisition module including an image sensor and a first lens system, the first lens system having a focal plane configured to image an object onto the image sensor;
a display module which displays the image captured by means of the image acquisition module such that a user can perceive it with one eye; and
a control unit including a measuring module configured to measure the accommodation state of the eye of the user, wherein the control unit adjusts the position of the focal plane of the first lens system on the basis of the measured accommodation state and, at the same time, adjusts displaying of the image by means of the display module on the basis of the measured accommodation state such that the user can perceive the displayed image in sharp definition with his eye having the measured accommodation state.

2. The imaging device according to claim 1, wherein the display module includes an imaging system and a second lens system, the second lens system configured to project the image generated by means of the imaging system into an image plane, wherein the control unit adjusts the position of the image plane on the basis of the measured accommodation state.

3. The imaging device according to claim 2, wherein the second lens system projects the image generated by means of the imaging system as a virtual image.

4. The imaging device according to claim 3, wherein the refractive power of the second lens system is alterable in order to adjust the position of the image plane.

5. The imaging device according to claim 4, wherein the distance between the second lens system and the imaging system is alterable in order to adjust the position of the image plane.

6. The imaging device according to claim 3, wherein the distance between the second lens system and the imaging system is alterable in order to adjust the position of the image plane.

7. The imaging device according to claim 2, wherein the distance between the second lens system and the imaging system is alterable in order to adjust the position of the image plane.

8. The imaging device according to claim 2, wherein the refractive power of the second lens system is alterable in order to adjust the position of the image plane.

9. The imaging device according to claim 8, wherein the distance between the second lens system and the imaging system is alterable in order to adjust the position of the image plane.

10. The imaging device according to claim 1, wherein the measuring module continuously measures the accommodation state of the eye.

11. The imaging device according to claim 1, wherein the measuring module measures the accommodation state of the eye confocally.

12. The imaging device according to claim 1, wherein the control unit alters the position of the focal plane of the first lens system such that this alteration is proportional to the measured alteration of the accommodation state of the eye.

13. The imaging device according to claim 1, wherein the control unit alters the position of the focal plane of the first lens system such that there is a functional relationship to the measured alteration of the accommodation state of the eye, wherein the functional relationship is not a proportional relationship.

14. The imaging device according to claim 1, wherein the measuring module uses infrared radiation to measure the accommodation state of the eye.

15. An imaging method, comprising
imaging an object onto an image sensor with an image acquisition module which comprises the image sensor and a first lens system having a focal plane;
capturing the image by means of the image acquisition module;
displaying the image with a display module such that a user can perceive it with one eye;
measuring an accommodation state of the eye of the user; and
adjusting a position of the focal plane of the first lens system on the basis of the measured accommodation state, and at the same time, adjusting the displaying of the image by means of the display module on the basis of the measured accommodation state such that the user can perceive the displayed image in sharp definition with his eye having the measured accommodation state.
